(19) United States
(12) Patent Application Publication
(10) Pub. No.: US 2015/0321170 A1
(43) Pub. Date: Nov. 12, 2015

(54) NON-LINEAR ABSORPTION MATERIALS BASED ON METALORGANIC FRAMEWORK (MOF) MOTIFS

(71) Applicant: UNIVERSITY OF FLORIDA RESEARCH FOUNDATION, INC., GAINESVILLE, FL (US)

(72) Inventors: KIRK S. SCHANZE, GAINESVILLE, FL (US); GALYNA DUBININA, NEWARK, DE (US)

(21) Appl. No.: 14/588,748

(22) Filed: Jan. 2, 2015

Related U.S. Application Data
(60) Provisional application No. 61/923,513, filed on Jan. 3, 2014.

(51) Int. Cl. B01J 20/22; C07F 15/00

(52) U.S. Cl. CPC B01J 20/226; C07F 15/0093

(57) ABSTRACT

Supramolecular coordination complex (SCC), are prepared that have acceptor-donor-acceptor linkers (ADA linkers) or donor-acceptor-donor linkers (DAD linkers) that bind to metal cations of secondary building units (SBUs). The ADA linker has a donor unit between acceptor units and the DAD linker has an acceptor unit between donor units where the linkers have terminal electron pair donor groups for binding to the metal cations of the SBUs. The SCC can be in the form of a metal-organic framework (MOF). The SCCs are useful as non-linear absorption materials.

### CROSS-REFERENCE TO RELATED APPLICATION

The present application claims the benefit of U.S. Provisional Application Ser. No. 61/923,513, filed Jan. 3, 2014, which is hereby incorporated by reference herein in its entirety, including any figures, tables, or drawings.

This invention was made with government support under FA9550-09-1-0186 awarded by the Air Force Office of Scientific Research. The government has certain rights in the invention.

### BACKGROUND

Over the last two decades metal-organic frameworks (MOFs) have been developed using widely applicable modular construction principles. Most of these highly porous MOF materials displayed low stability. Good stability is observed for 12 coordinated zirconium cluster Zr₆O₄(OH)₄(CO₂)₁₂. MOFs, such as UiO-66, can be formed between a linear dicarboxylate ligand, such as 1,4-benzenedicarboxylate and a secondary building unit (SBU) that is constructed of six zirconium cations, which form an octahedron, where each Zr is coordinated in a square-antiprismatic geometry by bridging μ₃-O, μ₃-OH, and carboxylate groups provided by the dicarboxylate ligand. Use of these MOFs in catalysis, hydrogen generation, selective adsorption, and drug delivery has been examined.

MOFs that are iso-reticular to UiO-66 have been reported with the designations UiO-67, UiO-68, and PIZOF-1-PIZOF-8 based on the dicarboxylate ligand employed. These materials form 12-connected networks with fcu topology. Synthesis of isoreticular Zr-MOFs can be modulated by the addition of mono-carboxylic acids, such as acetic and benzoic acid which act as ligands competing with the dicarboxylate ligands. The modulators can permit the formation of crystals in different well-defined sizes, depending on the proportions of modulator added during the synthesis.

MOFs are crystalline materials, which create a highly ordered and well-defined structure in which the position of all framework atoms is known. These materials can be tuned to form a desired structure by choice of the inorganic and organic components. For this reason, the modification of a MOF to contain ligands with functionality to modify the properties of a MOF is intriguing. To this end, the development of MOFs with ligands that include electron donors and electron acceptors has the potential for uses in photovoltaics and even as non-linear light absorbing materials.

### BRIEF DESCRIPTION OF DRAWINGS

FIG. 1 shows: a) a generalized structure of a chromophore exhibiting efficient dual mode 2PA/ESA multiphoton absorption and b) a four level Jablonski diagram for the 2PA/ESA chromophore.

FIG. 2 shows a representation of portion of a zigzag Zn-MOF structure, according to an embodiment of the invention.

FIG. 3 shows absorption and emission spectra of a MOF-TBT-Zn dispersion in THF and of the TBT-free ligand.

FIG. 4 shows absorption and emission spectra of MOF-TBT-Zn (dispersion in THF), TBT-free ligand, and MOF-TBT-Zn-bpy.

FIG. 5 shows UV-VIS and emission spectra for: a) TBT-Zr-DMF; and b) C2-Zr-DMF/DEF.

FIG. 6 shows a photograph of the TBT ligand and Zn- and Zr-MOF materials under emission.

FIG. 7 shows PXRD spectra of the various Zr-MOFs, according to embodiments of the invention.

FIG. 8 shows TEM/SEM Images of MOFs material, according to embodiments of the invention.

FIG. 9 shows TA spectra of TBT MOFs, according to embodiments of the invention.

FIG. 10 shows TA spectra of a) MOF-Zn-TBT and b) free TBT ligand.

FIG. 11 show representative TGA spectra of MOFs, according to embodiments of the invention.

FIG. 12 show the setup for the preparation of a Pt(II) SCC by a slow diffusion method.

FIG. 13 shows ¹H- and ³¹P-NMR spectra that illustrate the formation of SCC for Pt(II) complexes upon diffusion of a non-polar solvent hexane into a polar solvent, dichloromethane, according to an embodiment of the invention.

FIG. 14 shows ¹H-NMR spectra that illustrate the deformation of SCC for Pt(II) complexes when placed in dichloromethane, according to an embodiment of the invention.

FIG. 15 shows the absorption spectra for Pt(II) SCC formation and the free ligand, according to an embodiment of the invention.

### DETAILED DISCLOSURE

Embodiments of the invention are directed to MOFs and SCCs incorporating pi-conjugated donor-acceptor-donor ligands (DAD), such as the dicarboxylate from (5,5′-(benzo[c][1,2,5]thiadiazole-4,7-diyl)bis(thiophene-2-carboxylic acid), (TBT). These cage-like structures incorporate pi-conjugated linkers held in a framework by metal-based secondary building units. The linkers have a multiplicity of units where an acceptor (A) is isolated and flanked by donors (Ds). In other embodiments of the invention, the pi-conjugated linkers are acceptor-donor-acceptor (ADA) linkers. The linkers are bidentate ligands that are chromophores capped at the ends with carboxylate groups (—COO⁻), amines (≡N:), or other electron pair donors, and are sufficiently ridged that each electron pair donor links to a metal cation of different SBUs in the MOF structures. The metal cations can be heavy metal cations. The electron pair donor can be an anion that is a counter ion to the metal ion or it can be a neutral ligand. The D-A-D design affords the linkers with moderate two-photon absorption (2PA) absorptivity in the near-infrared spectra region, and their 2PA cross sections vary with acceptor strength. They show singlet and triplet properties that depend on the metal and structure type. For example, MOF-TBT-Zn is not emissive while the free TBT ligand is emissive. However, MOF-TBT-Zn exhibited strong triplet-triplet absorption in its nanosecond transient absorption spectrum. The same type of Zn-MOF structure, modified with 2,2′-bipyridine (bpy) as an additional linker, shows strong fluorescence but a marginal triplet state.

The SCCs, according to embodiments of the invention allow efficient dual mode two photon absorption excited state absorption, in the manner shown for a model system in FIG. 1a where the organic ligands are attached to a heavy metal such as Zr that exhibits a four level Jablonski diagram, as in FIG. 1b.

Embodiments of the invention are directed to the preparation of organometallic and metal-organic non-linear absorption materials having supramolecular coordination complexes (SCC) and metal-organic framework (MOF) motifs. These cage-like structures incorporate pi-conjugated linkers held in a framework by metal-based secondary building units (SBUs). The MOFs are related to known Zn- and Zr-ter-phenyl MOFs (Zr: UiO-68), where a series of MOFs incorporating pi-conjugated donor-acceptor-donor ligands, such as TBT are prepared. The SCC and MOF based materials can be characterized by photo-physical techniques such that their non-linear absorption properties can be readily assessed using 2PA and nanosecond non-linear transmission techniques.

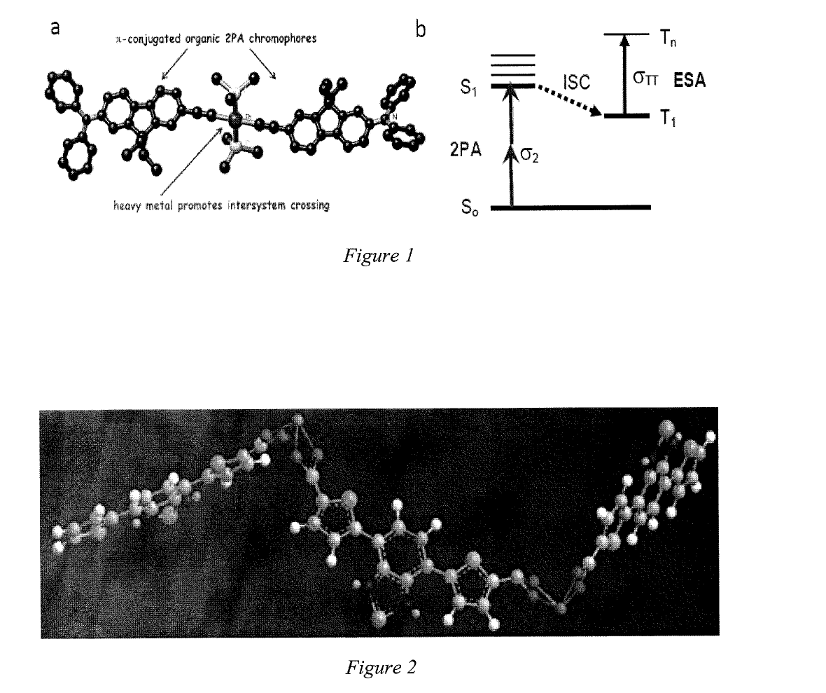

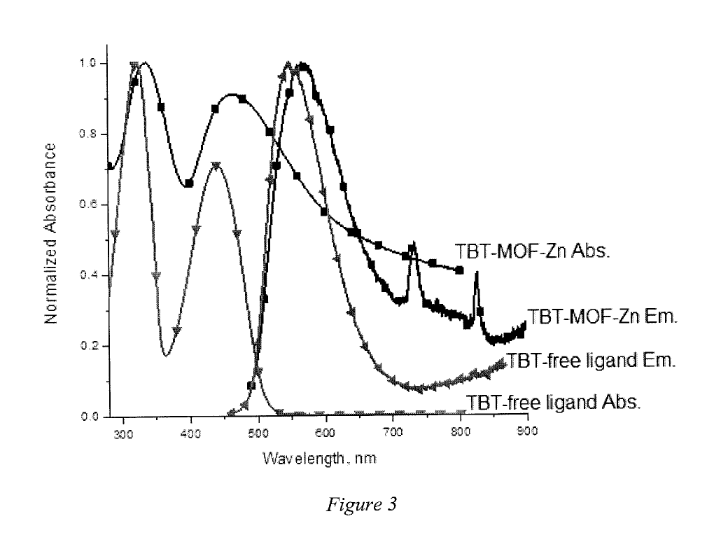

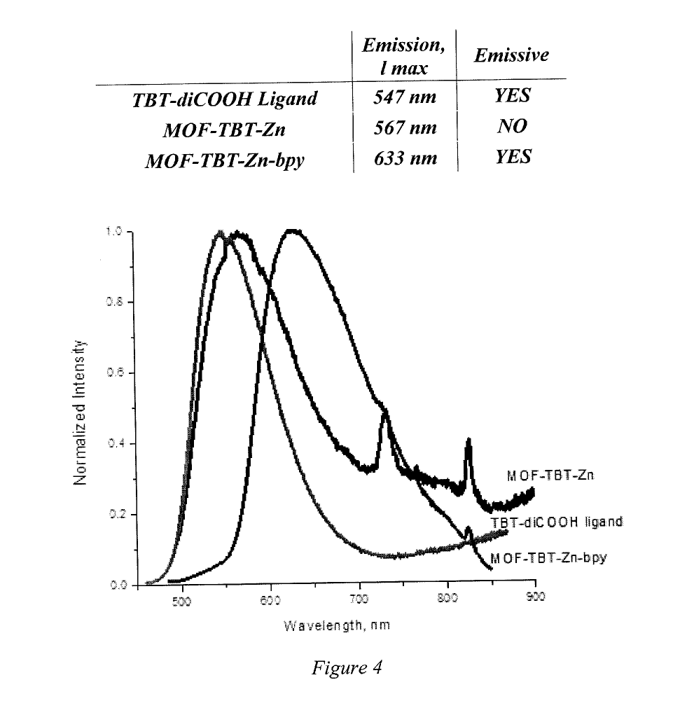

The SCC can display a zigzag Zn-linker structure as shown in FIG. 2 within a MOF-TBT-Zn structure. Such a MOF displays absorption and emission spectra when dispersed in a solvent, such as THF, where the spectrum of the suspended MOF differs from that of the free TBT ligand, as shown in FIG. 3. Modification by an addition linker, such as bpy is demonstrated in FIG. 4, which shows absorption and emission spectra of MOF-TBT-Zn and MOF-TBT-Zn-bpy suspended in THF.

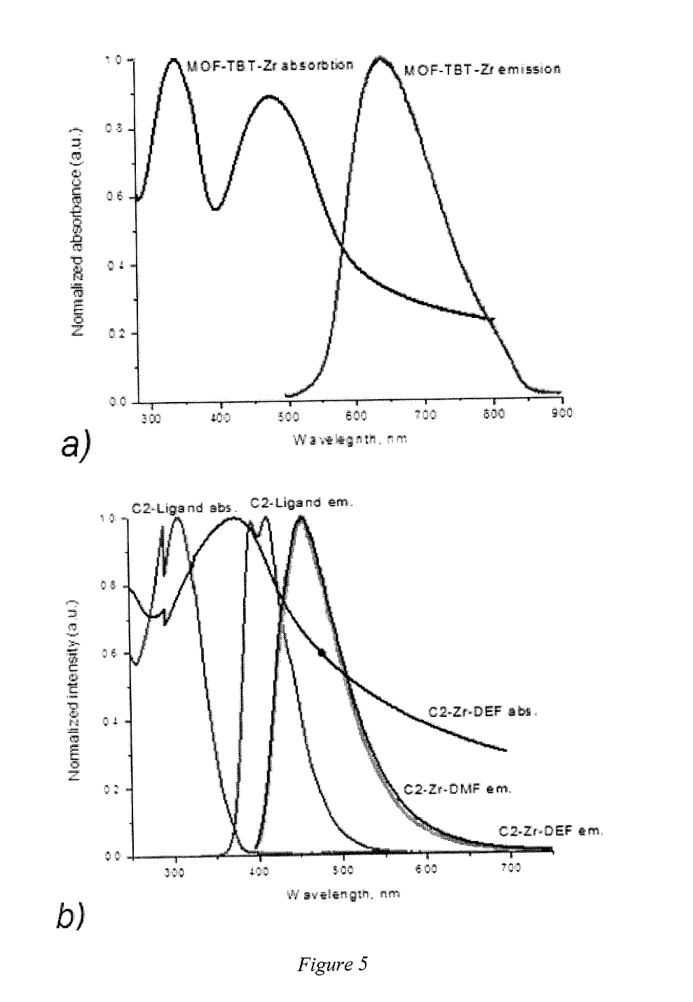

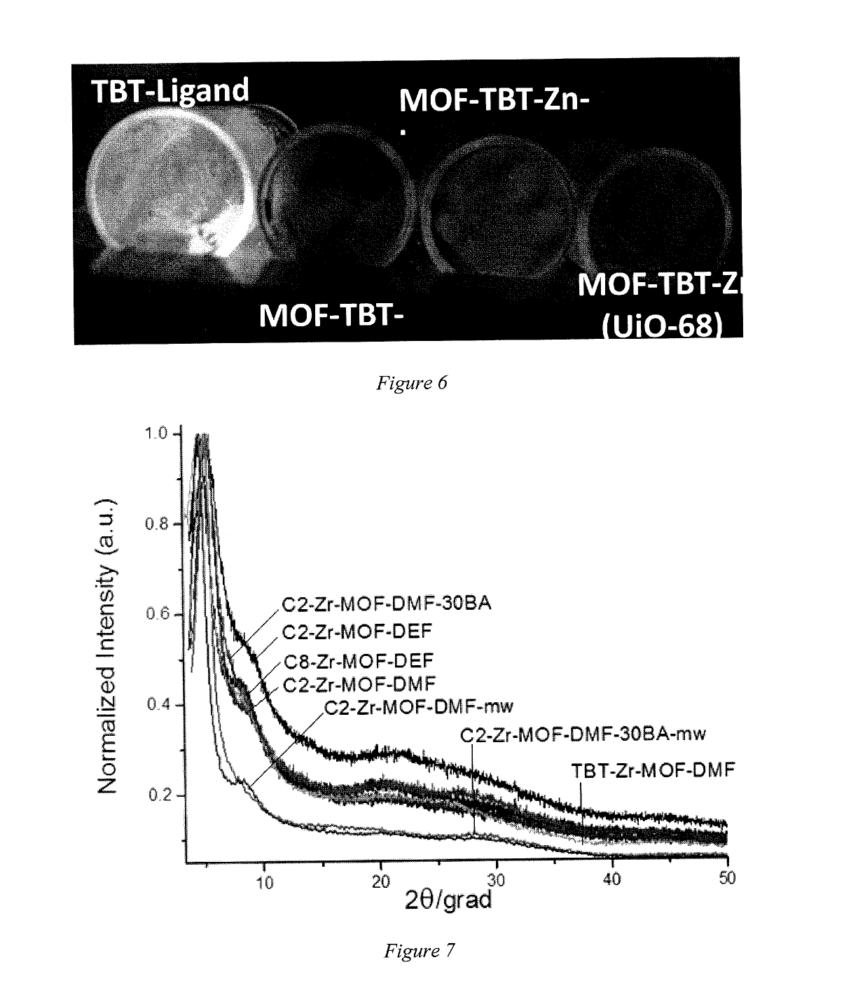

The UiO-68-like zirconium based MOFs, according to embodiments of the invention, are more stable toward moisture and solvents, and can be characterized by PXRD, TEM, SEM, TGA, and other methods. For example, to grow single crystals suitable for X-Ray diffraction, more soluble model linker precursors, 5,5′-(2,5-diethyl-1,4-phenylene)bis(thiophene-2-carboxylic acid) and 5,5′-(2,5-dioctyl-1,4-phenylene)bis(thiophene-2-carboxylic acid), were synthesized and applied to form UiO-68-like, zirconium-based MOFs. Two-photon absorption spectra and cross sections on index matched samples are obtained by using the femtosecond NLT as shown in comparison to TBT materials in FIG. 5. Emission from the MOF with different metal cations is shown in FIG. 6 relative to the TBT ligand alone. FIG. 7 shows how the PXRD spectra varies with the composition and conditions of the Zr-MOFs, where mono-dentate ligands, BA, and the solvent.

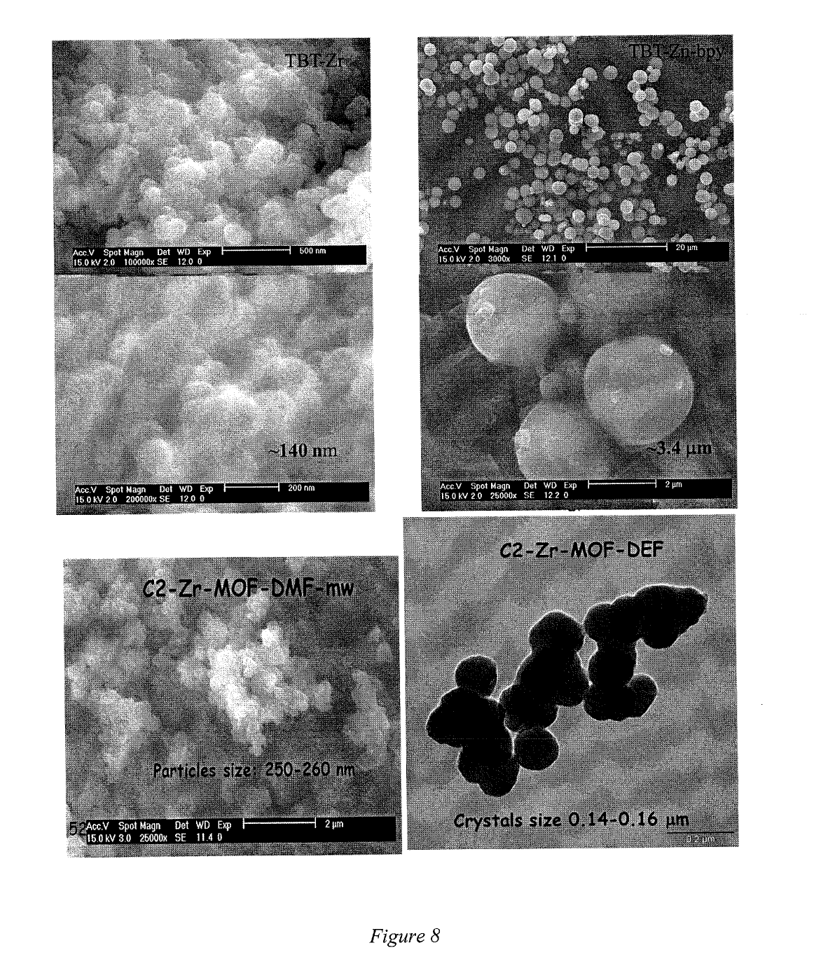

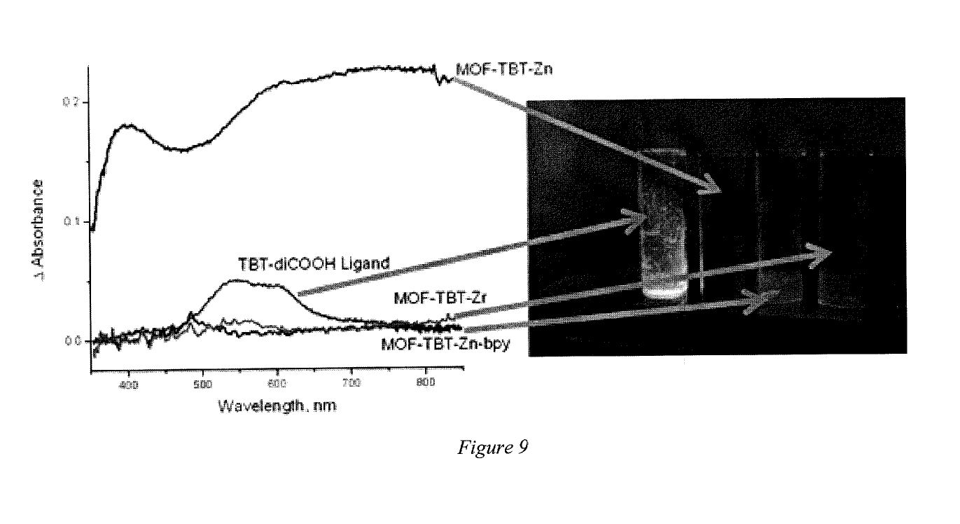

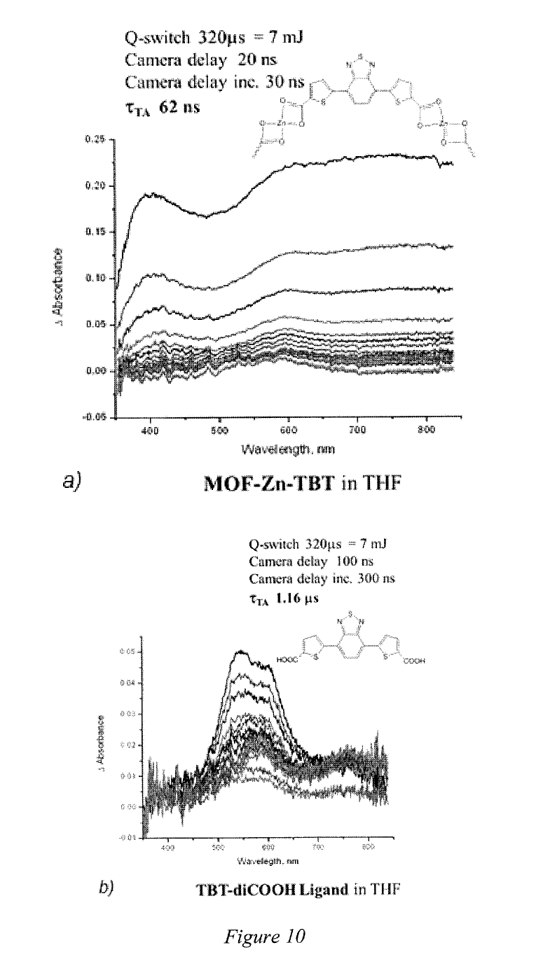

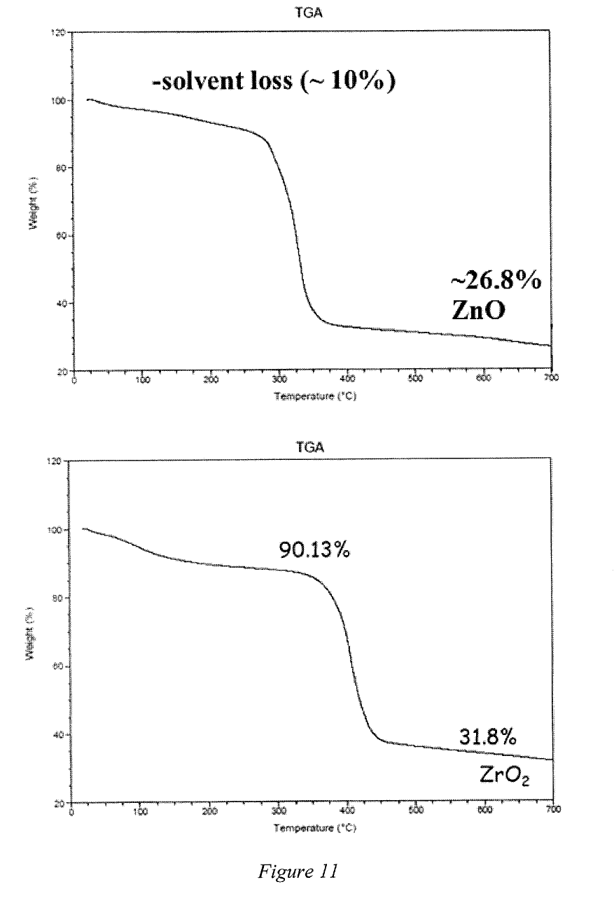

The MOFs can be of a broad range of particle sizes, ranging from about 100 nm to about 5 microns, as shown in the TEM/SEM images of FIG. 8. These materials give transient-absorption (TA) spectra depending on the composition, as shown in FIGS. 9 and 10. The stability of the MOFs, according to embodiments of the invention are indicated in the thermogravimetric (TGA) spectra shown in FIG. 11

These MOFs are advantageous as non-linear absorption materials. In an embodiment of the invention, composites of the MOFs are prepared in glassy high index host polymers, such as polycarbonates and polyacrylates. The MOF/polymer composites are advantageous for advanced non-linear absorption optical materials.

The ligands are prepared by the condensation shown in Equation 1 for TBT, below:

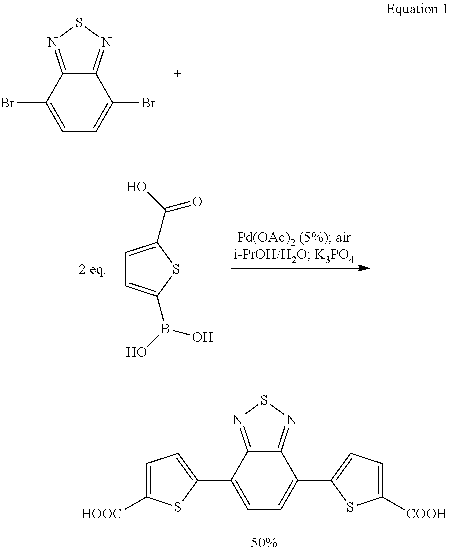

These ligands permit the combination with the transition metals, as exemplified with Zn, to form a zig-zag structure, as shown in Equation 2, below.

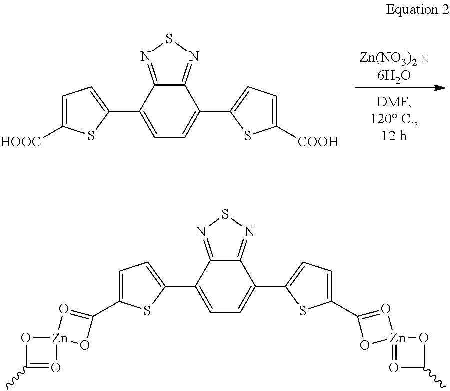

The zig-zag complexes, as shown in FIG. 2, can be extended in three dimensions as shown in Equation 3, below, by the coordination of bpy between Zn centers of the complexes.

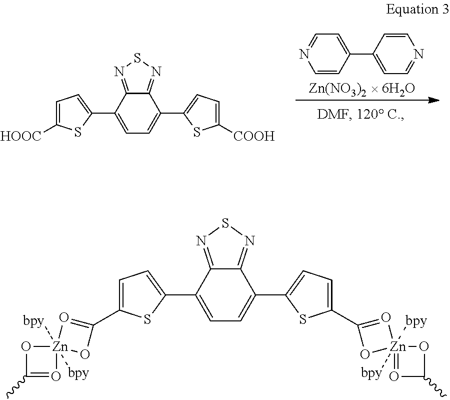

Other MOFs according to embodiments of the invention can be prepared as illustrated in Equations 4-6 below.

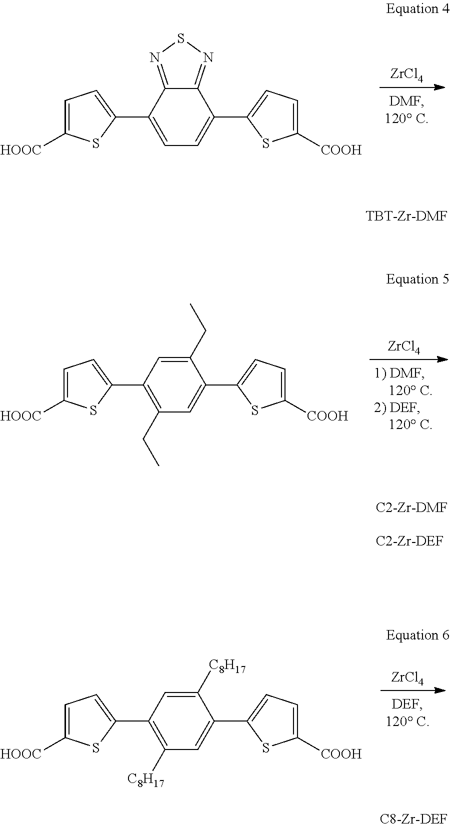

Photophysical studies show trends in singlet and triplet properties depends on the metal and structure type. For example, MOF-TBT-Zn material turns to be not emissive in comparison with the emissive start TBT-ligand but exhibited strong triplet-triplet absorption in nanosecond transient absorption spectrum. The same type of Zn-MOF structure, modified with bpy 3D-linker, showed strong emission but the marginal triplet state.

The MOFs synthetic conditions are characterized in Table 1, below.

TABLE 1

| | Microwave | Particle |
|---|---|---|
| MOF | time in min | Size in nm |
| TBT-Zr-DMF | | 120-140 |
| C2—Zr-DMF | | 100-120 |
| C2—Zr-DEF | | 140-160 |
| C2—Zr-DMF-mw | 30 | 240-260 |
| C2—Zr-DMF-30BA | | |
| C2—Zr-DMF-30BA-mw | 30 | |
| C8—Zr-DEF | | 100-120 |

Microwave conditions: 150 W; all at 120° C.;
BA = Benzoic Acid

Supramolecular coordination complexes (SCCs) are prepared as indicated in Equation 7, below. The cage-like Pt(II) linked molecular squares based on A-D-A ligands was synthesized by slow diffusion method at −20° C., and the equilibrium in solutions were studied along with photophysical properties. The SCC displays a molar extinction coefficient of 107,000 (M⁻¹ cm⁻¹) in DCM for Square (dppp) with a fluorescence lifetime of 2.096 (83.1%); 0.799 (16.9%).

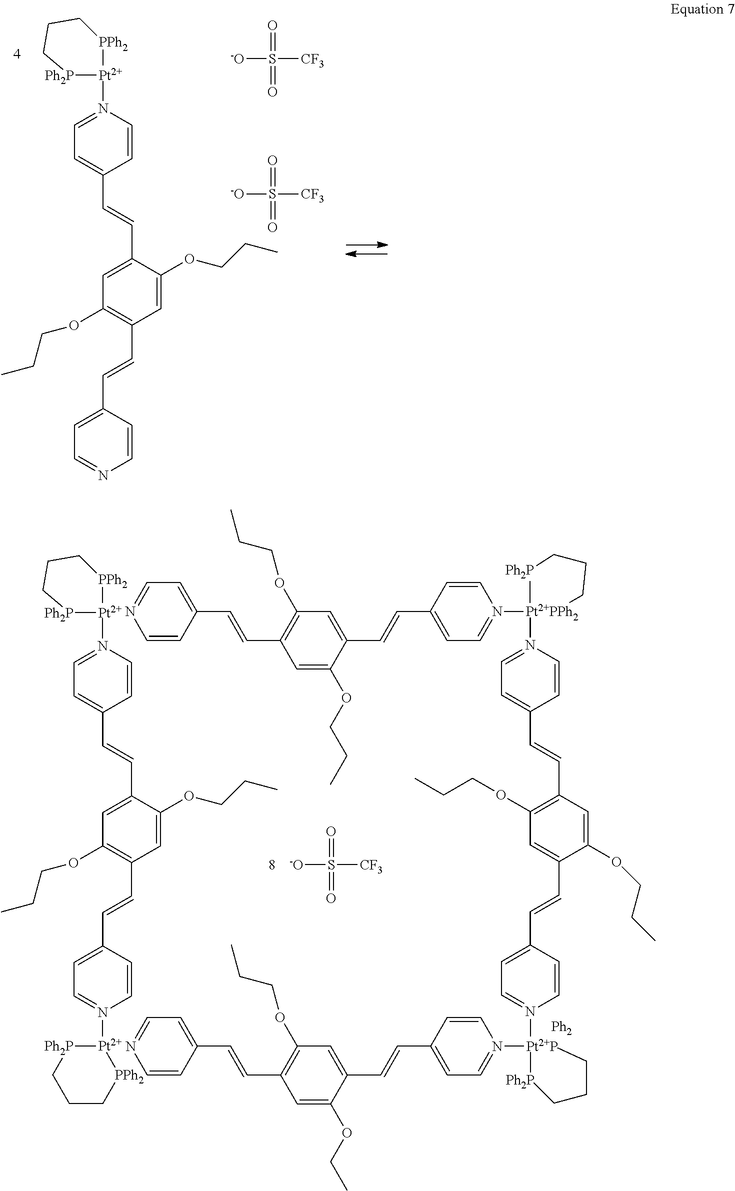

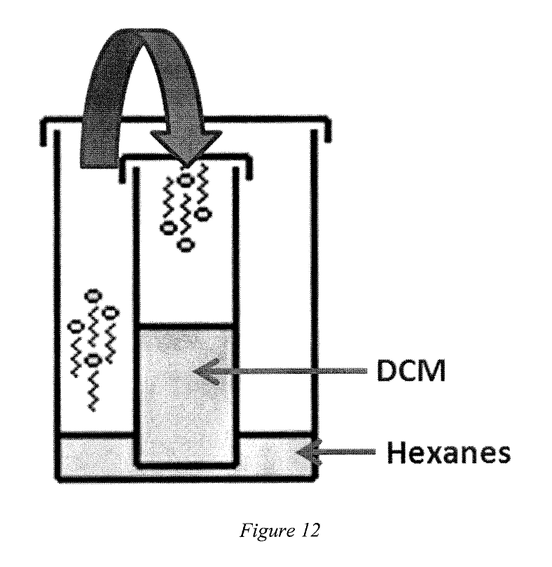

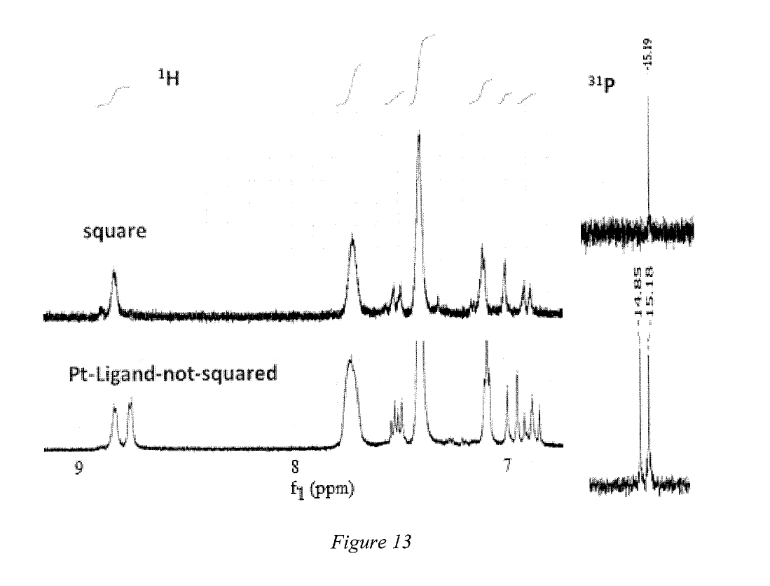

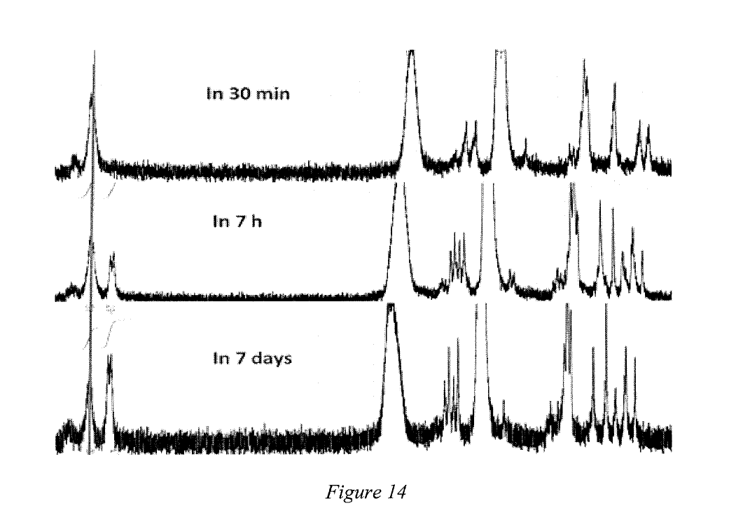

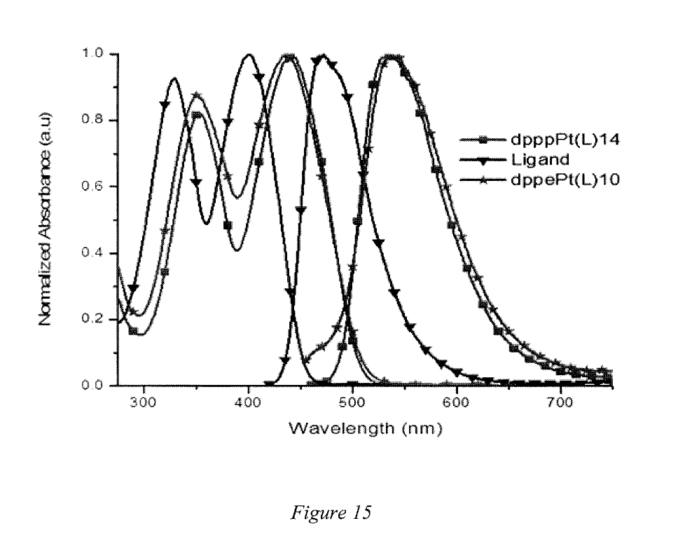

These SCCs are prepared by a slow diffusion method, as indicated in FIG. 12 for the Pt(II) SCC, for diffusion of a non-polar solvent, hexane, into a polar solvent, dichloromethane, at −20° C. As indicated in FIG. 13 by ¹H- and ³¹P-NMR spectra, the SCC for Pt(II) complexes are formed, where these complexes can be deformed by polar solvents, such as dichloromethane, as indicated in the ¹H-NMR spectra of FIG. 14. FIG. 15 shows the absorption spectra for Pt(II) SCC formation and the free ligand where a molar ext. Coefficient of 107,000 (M-1 cm-1) in DCM is observed for Square(dppp) and where the fluorescence Lifetime: 2.096 (83.1%); 0.799 (16.9%).

It should be understood that the examples and embodiments described herein are for illustrative purposes only and that various modifications or changes in light thereof will be suggested to persons skilled in the art and are to be included within the spirit and purview of this application.

We claim:

1. A supramolecular coordination complex (SCC), comprising an acceptor-donor-acceptor linker (ADA linker) or a donor-acceptor-donor linker (DAD linker), wherein the ADA linker has a donor unit between acceptor units, or a wherein the DAD linker has an acceptor unit between donor units, and wherein the ADA linker or DAD linker has terminal electron pair donor groups for binding to a secondary building unit (SBU) comprising a metal cation to form a SCC.

2. The SCC according to claim 1, wherein the terminal electron pair donor groups are —CO₂⁻ or ≡N: groups.

3. The SCC according to claim 1, wherein the SCC is a metal-organic framework (MOF).

4. The SCC according to claim 3, wherein the DAD linker comprises a thiadiazole acceptor unit and thiophene donor units and the metal cations comprises Zr cations.

5. The SCC according to claim 3, wherein the DAD linker is 5,5′-(benzo[c][1,2,5]thiadiazole-4,7-diyl)bis(thiophene-2-carboxylate.

6. The SCC according to claim 1, further comprising an additional linker comprising terminal electron pair donor groups.

7. The SCC according to claim 6, wherein the additional linker is 2,2′-bipyridine (bpy).

8. The SCC according to claim 1, wherein the DAD linker is 5,5′-(2,5-diethyl-1,4-phenylene)bis(thiophene-2-carboxylate) or 5,5′-(2,5-dioctyl-1,4-phenylene)bis(thiophene-2-carboxylate and the metal cation is a Zr cation.

9. The SCC according to claim 1, further comprising a monodentate ligand.

10. The SCC according to claim 9, wherein the monodentate ligand is benzoate.

11. The SCC according to claim 1, wherein the ADA linker is 1,4-bis(4-pyridylethynyl)-2,5-(propyloxy)benzene and the metal cation is Pt cations.

12. A non-linear absorption material, comprising a SCC, according to claim 1.

13. The non-linear absorption material according to claim 12, further comprising an organic polymer.
